(19) United States
(12) Patent Application Publication
(10) Pub. No.: US 2024/0088616 A1
(43) Pub. Date: Mar. 14, 2024

(54) SLIDE SOCKET

(71) Applicant: WILLIE OWENS, Canton, GA (US)

(72) Inventor: WILLIE OWENS, Canton, GA (US)

(21) Appl. No.: 17/943,258

(22) Filed: Sep. 13, 2022

(51) Int. Cl. H01R 31/02

(52) U.S. Cl. CPC H01R 31/02

(57) ABSTRACT

A surge protector apparatus with expandable outlets that move independently with sockets that rotate 180 or 360 degrees. Each outlet attaches to a circuit board or bus bar independently. The apparatus connects to a wall outlet to extend to multiple outlets. The embodiment includes two brackets located on the side of the apparatus to make hanging easier. The preferred embodiment includes a accessory outlet connection and cover to engage accessory outlet and USB connections. The apparatus includes a on/off switch, accessory USB and accessory outlet connection for extension of said apparatus.

### BACKGROUND OF THE INVENTION

This invention is centered in the field of home and office electronics. Though not a novel item, the invention introduces a new method of a power extension socket whereby this extension contains retractable individual sockets and also a retractable voltage surge protector on the right side of the slide socket.

### BRIEF SUMMARY OF THE INVENTION

This invention comes in to introduce a power extension cable with retractable charging ports which essentially saves power by only providing electric voltage to plugged in charging sockets. It also introduces a 2 in 1 power extension cable and voltage surge protector. The invention gives the buyer the option of purchasing the two in one power extension cable or only a power extension cable without a voltage surge protector. Third, the voltage surge protector has USB charging ports introducing a power extension cable with USB charging ports.

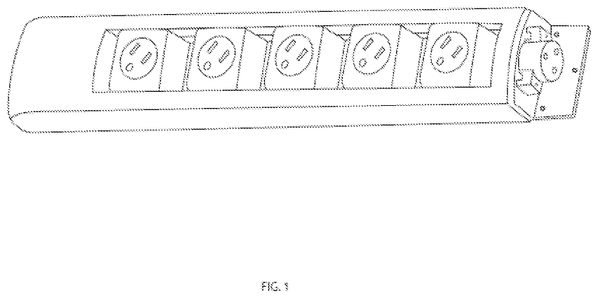

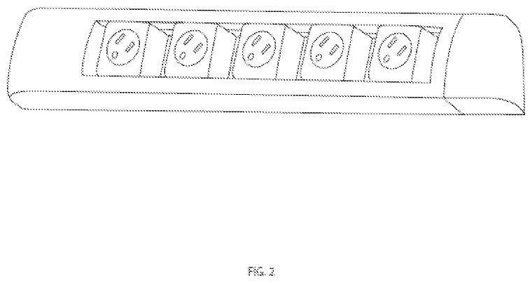

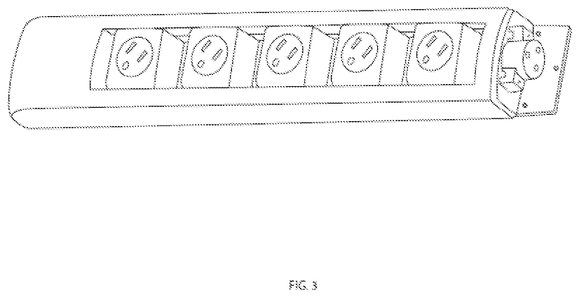

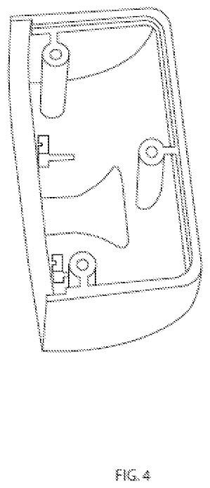

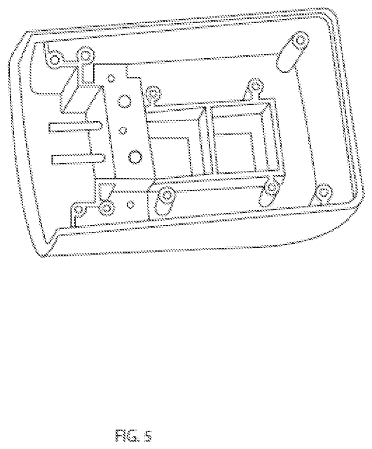

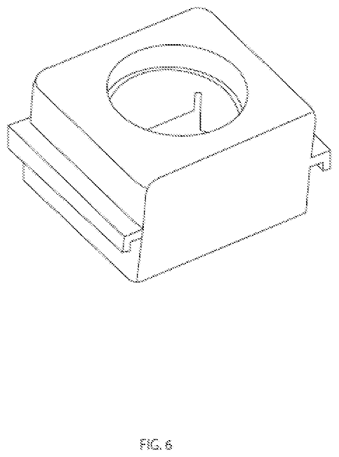

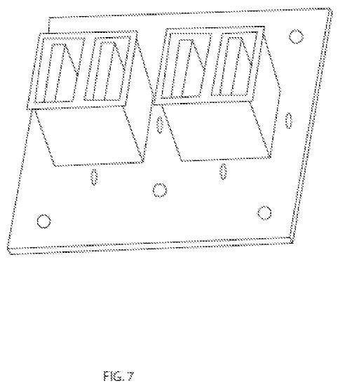

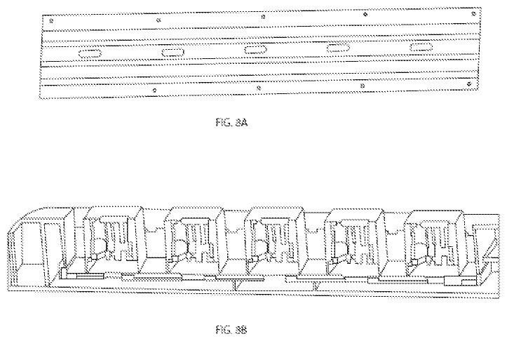

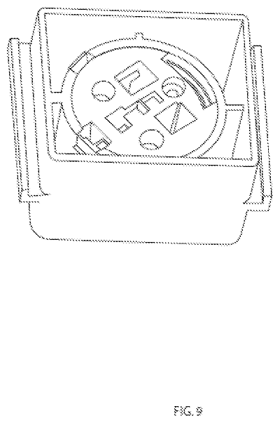

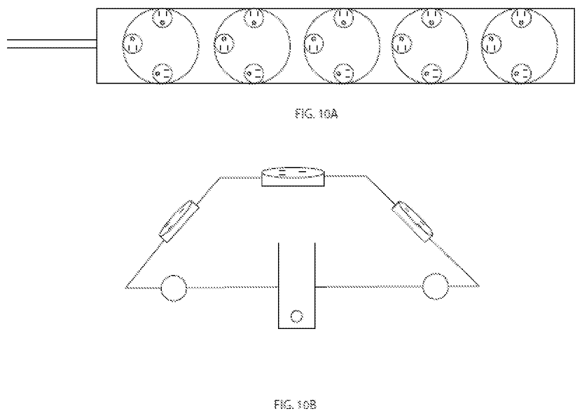

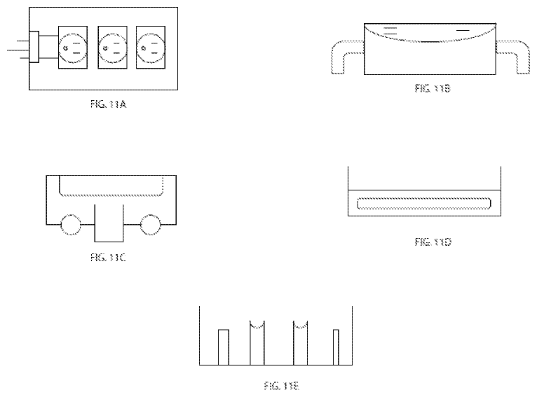

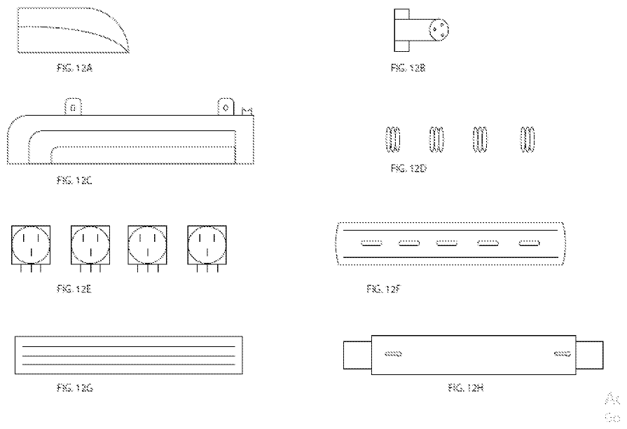

### BRIEF DESCRIPTION OF SEVERAL VIEWS OF THE DRAWING

| NUMBER | DESCRIPTION |
|---|---|
| FIG. 1 | Is the outline of the slide socket. The first diagram |
| | shows the upper casing of the socket and its wall |
| | mounting ports. The second diagram shows the |
| | sockets. The third diagram shows the retracting |
| | ports of the sockets while the fourth diagram shows |
| | the bottom case of the slide socket. |
| FIG. 2 | Shows the top plan of the slide sockets. It has one |
| | socket plugged in at the middle while the others |
| | are as the slide socket will appear without the charging |
| | socket ports plugged in. |
| FIG. 3 | Shows the slide socket with the voltage surge protector |
| | plugged out. The plugs shown are where the |
| | voltage surge protector on the right side of the slide |
| | socket shall be plugged. |
| FIG. 4 | Shows the surge protector plugs to the main slide |
| | socket |
| FIG. 5 | Shows the voltage surge protector as it appears |
| | without the case. At the top part of it are USB charging |
| | ports |
| FIG. 6 | Shows the voltage surge protector with its protective |
| | case on. |
| FIG. 7 | Shows the voltage surge protector's casing. |
| FIG. 8 | Shows the casing of the slide socket whereby a client |
| | can elect not to purchase the slide socket together with |
| | a voltage surge protector. |

1. I, Willie owens, the inventor of the utility patent described above claims all patent rights to a power extension cable with retractable sockets/charging ports or what has been referred to above as slide sockets.

2. I, Willie Owens, the inventor of the utility patent described above claims all patent rights to a power extension cable with a retractable voltage surge protector that can be purchased either as a 2 in 1 power extension cable and voltage surge protector or a power extension cable with available ports to connect a voltage surge protector.
